(19) United States
(12) Patent Application Publication
(10) Pub. No.: US 2025/0127599 A1
(43) Pub. Date: Apr. 24, 2025

(54) OPEN BITE POSITION SCANNING

(71) Applicant: Fresh Health Inc., Mountain View, CA (US)

(72) Inventors: Brent Goldstein, North Las Vegas, NV (US); Kristina Jenna Cook, El Cajon, CA (US); Rebecca Brinkhuis, San Jose, CA (US)

(21) Appl. No.: 18/908,556

(22) Filed: Oct. 7, 2024

Related U.S. Application Data
(60) Provisional application No. 63/591,397, filed on Oct. 18, 2023.

(51) Int. Cl. A61C 13/00; A61C 7/00; A61C 19/045

(52) U.S. Cl. CPC A61C 13/0004; A61C 7/002; A61C 19/045

(57) ABSTRACT

An upper arch model of a user is obtained. A lower arch model of the user is obtained. An image associated with an oral anatomy of the user is obtained. The image, the upper arch model, and the lower arch model are analyzed to determine a relative alignment between an upper arch of the user and a lower arch of the user. An oral insert is generated, having a plurality of fluid nozzles and a plurality of fluid manifolds for the user based on the analysis of the image, the upper arch model, and the lower arch model.

### CROSS REFERENCE TO OTHER APPLICATIONS

This application claims priority to U.S. Provisional Patent Application No. 63/591,397 entitled VIRTUAL ARTICULATION OF THE ORAL ANATOMY ASSOCIATED WITH A USER filed Oct. 18, 2023 which is incorporated herein by reference for all purposes.

### BACKGROUND OF THE INVENTION

Traditional dental and orthodontal work may be aided by scanning the upper mouth of a user or lower mouth of a user, for example, to observe the shape and position of teeth. It is an enhancement to also enable the ability to reasonably, efficiently, and accurately scan the upper and lower mouth together in a natural bite position for the user. For example, an oral health care device may include an oral insert customized to the oral anatomy of a user. The generation of said oral insert is improved by a scan of the oral anatomy of the user in an open bite position.

### BRIEF DESCRIPTION OF THE DRAWINGS

Various embodiments of the invention are disclosed in the following detailed description and the accompanying drawings.

FIGS. 1A, 1B, and 1C are diagrams illustrating an example of natural jaw kinematics for a given user in an open bite position.

FIG. 2A depicts an example of a traditional dental shim device.

FIGS. 2B and 2C depict an example of a traditional attachment joint.

FIGS. 3A and 3B depict an example of a traditional manual alignment using a dental shim device.

FIG. 4 illustrates a perspective view of an oral insert generated based on images of a user's oral anatomy in accordance with one embodiment.

FIG. 5 is a diagram illustrating an oral care system in accordance with one embodiment.

FIG. 6 depicts an example of a spacer shim device.

FIG. 7A is a flow diagram illustrating an embodiment of a process for open bite position scanning.

FIG. 7B is a flow diagram illustrating an embodiment of a process for open bite position scanning using captured motion.

FIG. 8 is a functional diagram illustrating a server for open bite scanning and/or generating an oral insert in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Open bite position scanning is disclosed. Each human may have an individual natural manner in which their upper and lower jaws open and close, referred herein as the jaw kinematics associated with the user. Traditional dental impressions and/or intraoral scanning capture an upper arch of the user's teeth, or the lower arch of the user's teeth, but fail to capture relative position between the upper arch and lower arch of the user's teeth.

In one embodiment, an oral health device includes a fluid reservoir, a pump, and an oral insert. The oral insert includes a plurality of manifolds and a plurality of fluid nozzles. The oral insert is coupled to the pump. Fluid is introduced into the fluid reservoir. A user may insert the oral insert into their mouth and subsequently activate the oral health device. The plurality of fluid nozzles are at locations customized to the oral anatomy of the user. When the oral health device is turned on, the pump causes fluid to exit the fluid reservoir and to be directed towards the oral anatomy of the user via the plurality of manifolds and the plurality of fluid nozzles. An improvement is that rather than spending two minutes on properly cleaning teeth with a toothbrush and toothpaste, the user spends as little as seven seconds cleaning teeth with the customized oral insert directing fluid to clean their mouth.

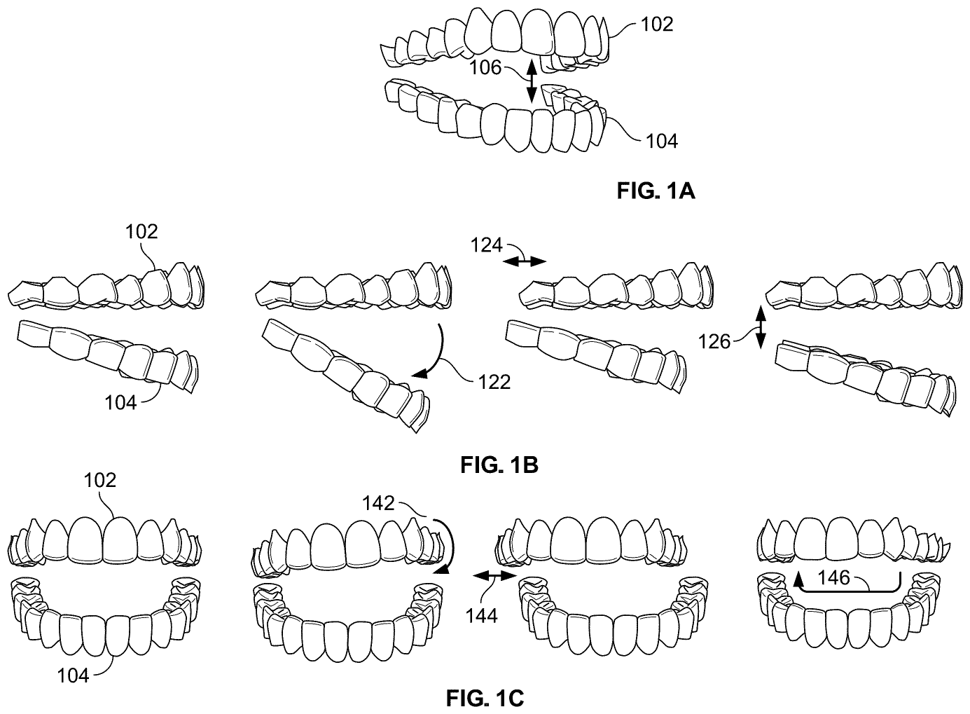

FIGS. 1A, 1B, and 1C are diagrams illustrating an example of natural jaw kinematics for a given user in an open bite position. In FIG. 1A, the upper arch of a user's teeth (102) and the lower arch of a user's teeth (104) in an open bite position are shown in a perspective view. The open bite position of FIG. 1A has a front incisor distance (106) between 10 mm and 25 mm to be useful for generation of an oral insert as described herein. The diagrams in FIGS. 1A, 1B, and 1C are not considered to scale and exaggerate rotation and translation for illustrative purposes.

In FIG. 1B, the same open bite position for the upper arch (102) and lower arch (104) from FIG. 1A is shown from a side view. For an application, such as generation of an oral insert, a particular open bite position may be optimal such as one between 10 mm to 40 mm between upper arch (102) and lower arch (104). As shown in FIG. 1B, if the bite position (122) is too high (or too low, not shown in FIG. 1B) the scan may not be as useful.

At the useful open bite position, jaw kinematics for a user may vary. For example, as shown in FIG. 1B, at a given bite position a user may have an overbite (124) (or an underbite, not shown in FIG. 1B). By way of another example, as shown in FIG. 1B, at a given bite position a user may have a different distance between the maxillary and mandibular posterior teeth (126).

In FIG. 1C, the same open bite position for the upper arch (102) and lower arch (104) from FIG. 1A is shown from a front view. Again, at the useful open bite position, jaw kinematics for a user may vary. For example, as shown in FIG. 1C, at a given bite position a user may have a different distance between the maxillary and mandibular teeth on the left versus right side, creating a relative rotation of the arches. between upper and lower arches (142). By way of another example, as shown in FIG. 1C, at a given bite position a user may have a crossbite (144). By way of another example, as shown in FIG. 1C, at a given bite position a user may have a relative yaw rotation between upper and lower arches (146).

As shown in FIGS. 1B and 1C, individual upper arch and lower arch scans are necessary but not sufficient to provide an open bite scan. The relative positioning of the two arch scans in terms of rotation and translation are required at a particular open bite position.

Traditional intraoral scanners and alginate dental impressions are designed to capture one arch at a time, whether the upper arch or lower arch. A “dental shim” may be used to attempt to position the user in a bite position and capture the arches together.

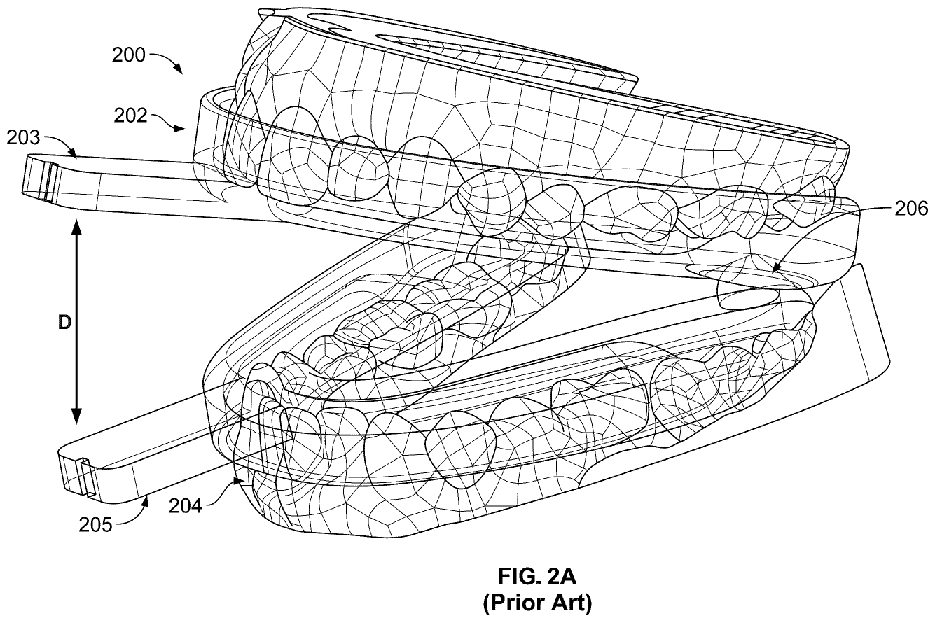

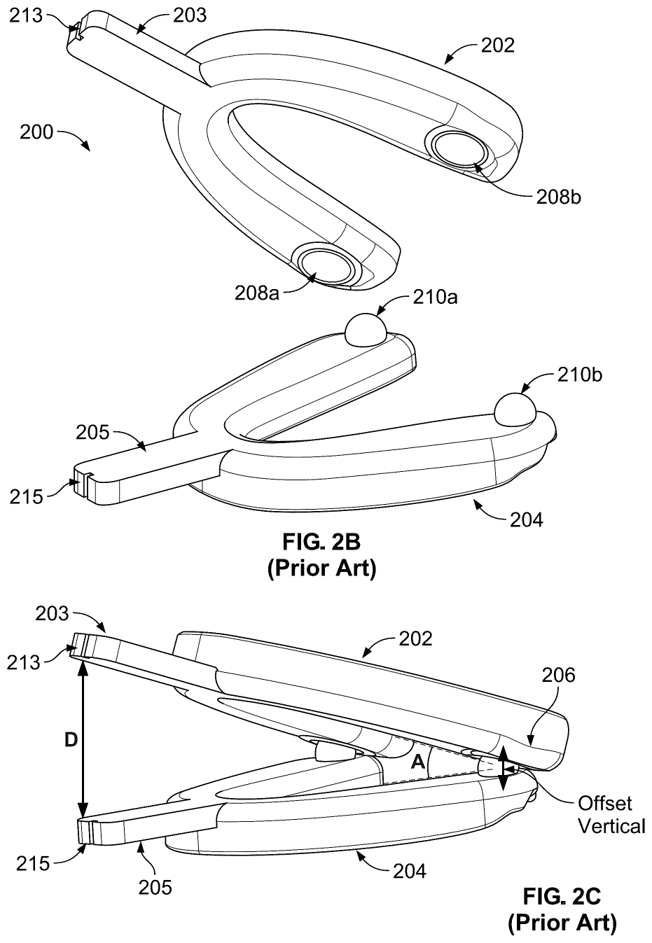

FIG. 2A depicts an example of a traditional dental shim device. In the example shown, the dental shim device (200) has been inserted into a user's mouth. The dental shim device (200) may comprise an upper tray (202) having an upper handle (203) that extends from a curved portion of the upper tray, a lower tray (204) having a lower handle (205) that extends from a curved portion of the lower tray, and an adjustable mating joint (206) that engages the upper tray and lower tray. The attachment joint/adjustable mating joint (206) may be configured to adjust a vertical offset and angle between the upper tray and the lower tray. The upper tray (202) and lower tray (204) may each have a trough comprising a surface that contacts upper teeth of an upper dental arch and the lower teeth of a lower dental arch, respectively. The upper and lower handles may each comprise a marker such as a notch (213), (215), as depicted in FIGS. 2B and 2C. When the shim device (200) is inserted in a user's oral cavity and clamped together by the user's jaws, the distance D between the upper notch (213) and the lower notch (215) may be measured and/or used with other scan data to determine the alignment between the upper and lower teeth and/or arches.

FIGS. 2B and 2C depict an example of a traditional attachment joint. The attachment joint/adjustable mating joint (206) may comprise a concave groove (208a) and/or (208b) and a corresponding protrusion (210) on the upper and lower trays, respectively. In this example, the protrusions (210a) and/or (210b) have the shape of a sphere that fits within the concave grooves (208a), (208b), respectively. When the upper and lower trays are not clamped within a user's mouth, the ball can move within the groove, however, when the trays are clamped within the user's mouth, the ball is retained at a particular location within the concave groove. The size and shape of the concave groove and the protrusion may be selected such that a desired vertical offset, for example Offset_{vertical}, is attained between the rear upper and lower teeth. For example, the concave groove may have an internal cavity with one or more curves, which may be cone-shaped, hemispheric, and/or any shape that allows for some motion of the protrusion within the groove to accommodate the different oral geometries of different users. With the measured distance value D and the selected/known vertical offset Offset_{vertical}, the angle A between the flat surfaces of the upper and lower trays may be calculated. These parameters, along with imaging data of the contours of the user's upper and lower teeth and gums, may allow automated determination of the alignment between the upper and lower teeth and/or dental arches. The determined alignment is used to generate an oral insert for a user.

Using an open bite position scanner as disclosed is an improvement over the traditional dental shim device shown in FIGS. 2A, 2B, and 2C because the shim may fit imperfectly for a given user, for example, Offset_{vertical} may not be a good fit for a user's hinge depth (126), which may misalign the user's open bite position for scanning.

Another improvement of using the open bite position scanner as disclosed is that the traditional dental shim device shown in FIGS. 2A, 2B, and 2C requires the manufacturing and distribution of the shim device and an in-person appointment for a user at a dental scan office which requires additional resources including increased material resources, increased manufacturing resources, increased design resources, increased shipping resources, and an increased amount of time.

Another improvement of using the open bite position scanner as disclosed is that the traditional dental shim device shown in FIGS. 2A, 2B, and 2C has an increased risk of poor arch orientation, referred herein as having poor alignment of the upper arch and lower arch relative to each other in comparison to the user's true physical arch orientation, as reflected in FIGS. 1B and 1C. Poor arch orientation may be due to, for example, something going wrong when physically inserting the shim in a user's mouth such as a technician not fitting the shim correctly, the user moving during scanning, and/or in post-processing a CAD (computer-aided design) technician not accurately manually aligning the upper arch and lower arch to the open bite scan.

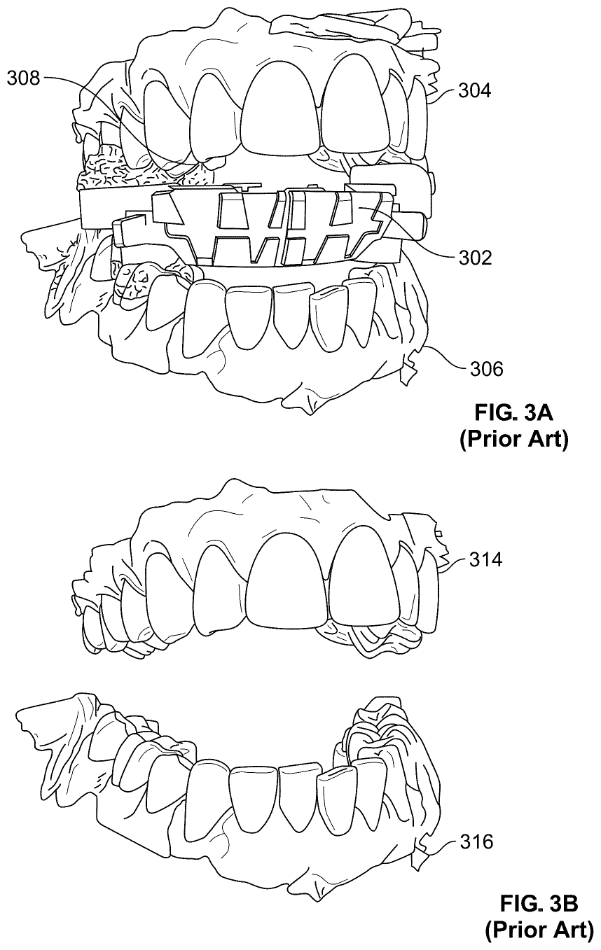

FIGS. 3A and 3B depict an example of a traditional manual alignment using a dental shim device. In one embodiment, the dental shim device (302) of FIG. 3A is the traditional dental shim device shown in FIGS. 2A, 2B, and 2C.

Traditionally in a first step, the dental shim device is inserted into a user's mouth at a dental scan office and an intraoral scan is taken, creating an open bite model as shown in FIG. 3A with the scan of the dental shim device itself (302), along with the upper arch (304) and lower arch (306) together. As shown in FIG. 3A, the dental shim scan may have imperfections (308) here shown in FIG. 3A as a movement and/or jitter in the scan where it appears like “multiple teeth” together (308).

Traditionally in a second step, the CAD technician then manually places and aligns an isolated upper scan (314) and an isolated lower scan (316) of the same user on top of the open bite model of FIG. 3A and then removes the open bite model to provide as a result the modeled natural jaw kinematics of the user, in order to then generate the oral insert for manufacturing.

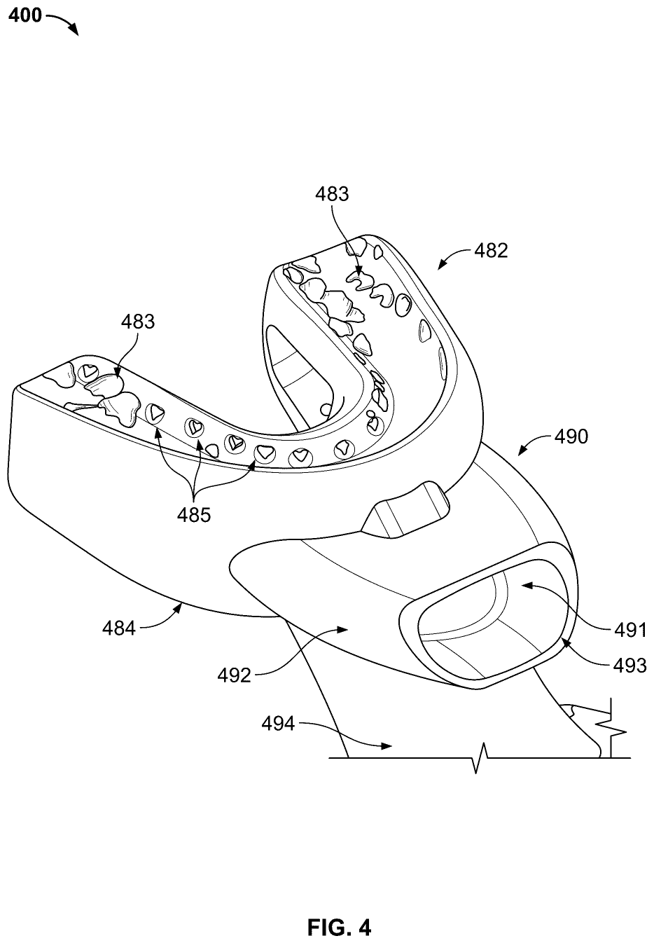

FIG. 4 illustrates a perspective view of an oral insert generated based on images of a user's oral anatomy in accordance with one embodiment. In the example shown, the oral insert (400) may be made of a rigid material, and may comprise an upper portion (482) having a tray configured to receive a user's upper teeth, a lower portion (484) having a tray configured to receive a user's lower teeth, a plurality of fluid nozzles located in the upper portion and the lower portion, and an effluence conduit (490) located between the upper portion and the lower portion.

The trays of the upper and lower portions may comprise one or more alignment features (483), which may comprise protrusions, slots, or recesses that receive and/or articulate with the user's teeth, gums, hard palate, soft palate, other oral structures, and/or may have contours that correspond to one or more teeth. These alignment features may help to ensure that the oral insert is seated in a desired position in the user's mouth. In some variations, one or more of the fluid nozzles may be located in recesses or indentations (485) along the teeth-facing and/or gingiva-facing surfaces of the upper and lower trays. The recesses (485) and the fluid nozzles may be located at regions of the upper and lower trays that correspond with the interproximal spaces between the user's teeth, and/or at locations that allow the fluid nozzles to direct fluid jets to the interproximal spaces (e.g., that may not necessarily correspond with the locations of the interproximal spaces).

The effluence conduit (490) may comprise a central port or channel (491) which may extend between a posterior region and anterior region of the oral insert, and may protrude forward at the anterior region as a beak or an elongated spout (492) that terminates at a fluid egress opening (493). The fluid exiting the central port or channel (491) may be provided to a sink or other collection device (e.g., a collector for microbiomes). Alternatively or additionally, an effluence conduit may comprise a first side fluid cavity or channel and a second side fluid cavity or channel. The side fluid cavities may funnel into the central port, or may each have their own elongated spouts with separate fluid egress openings. The shape, sizing, and surface contours of the effluence conduit may be configured according to the user's oral anatomy (e.g., size and size of oral cavity, location of teeth, etc.) and configured to promote fluid dynamic efficiency in draining the fluid from the user's mouth.

In one embodiment, the fluid delivered to the user's mouth may be pressurized and/or delivered at a high fluid rate in order to effectively clean their teeth and/or dislodge particles trapped in the interproximal spaces. Because of the increased rate and/or pressure of fluid flow into the oral cavity (i.e., fluid ingress), the effluence conduit of the oral insert may be sized and shaped to allow for fluid egress at the same or greater rate as fluid ingress. The oral insert (400) may also comprise one or more fluid manifolds, which may be a series of branched and/or networked internal fluid manifolds that distribute the fluid from the handle to the individual fluid nozzles. The fluid manifolds may terminate at a series of manifold openings in a manifold connector port (494) of the oral insert.

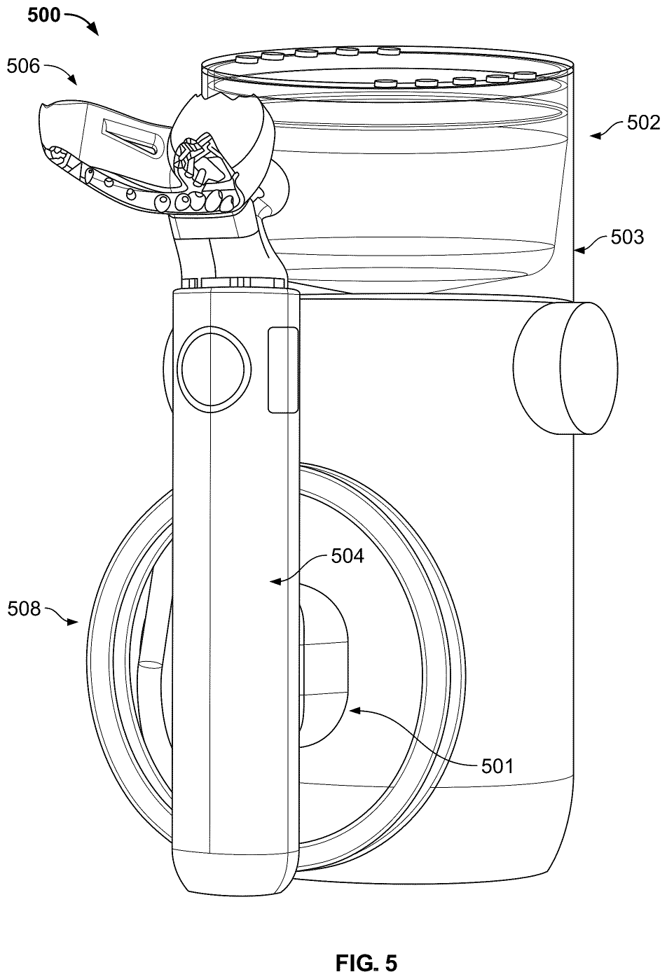

FIG. 5 is a diagram illustrating an oral care system in accordance with one embodiment. In the example shown, oral care system (500) includes base station (502) that is coupled to fluid reservoir (503), handle (504), and a customized oral insert (506) coupled to handle (504). The customized oral insert (506) may be generated based on a plurality of images of a user's oral anatomy. The customized oral insert (506) includes an upper portion and a lower portion that are sized and shaped according to a user's oral cavity. A plurality of fluid nozzles of the customized oral insert (506) are directed toward interproximal spaces between the user's teeth. The customized oral insert (506) further comprises an effluence conduit located between the upper portion and the lower portion and configured to channel fluid circulating within the user's mouth to an anterior or facial region of the user's oral cavity. One or more fluid conduits (508) may connect (501) fluid reservoir (503) to handle (504), which has a fluid regulator that distributes fluid to oral insert (506).

The customized oral insert (506) includes a plurality of fluid openings that are arranged in accordance with the unique geometry of the user's oral cavity, gingival geometry, dental structures, and any oral and/or dental devices or implants. Examples of oral and/or dental devices may include, but are not limited to, permanent and removal dental restorations/prosthetics, orthodontic appliances, crows, bridges, implants, braces, retainers, dentures, etc. Each of the fluid openings is positioned to target a specific dental feature. Inside of the customized oral insert (506), the fluid openings may be connected to one or more internal manifolds. The inlets of these manifolds may extend from the back of customized oral insert (506) in the form of a standardized connector, to which handle (504) and/or conduit (508) may be connected.

Open Bite Position Scanning. Virtual articulation is disclosed. As referred to herein, “virtual articulation” includes obtaining one or more images associated with a user's oral anatomy, a scan of the upper arch of the user's teeth, a scan of the lower arch of the user's teeth, and/or a scan of the user's teeth being in a closed position. As referred to herein, a “closed position” is when a user's upper and lower teeth are touching together. For a user, traditionally a dental office will readily capture and/or provide past scans of a user's upper arch scan and lower arch scan, without a dedicated visit by the user.

In one embodiment, virtual articulation includes obtaining an image of the user's teeth being in a completely or partially open position, and/or images of the user's teeth being in one or more intermediate positions, between the closed position and the completely open position. In one embodiment, at one of the one or more intermediate positions, the upper and lower jaws of the user are positioned as if an actual dental shim was inserted into the mouth of the user.

Open Bite Position Scanning using a Spacer Shim. In one embodiment, a physical spacer shim is inserted into the mouth of the user at their home or office. As referred to herein, a “spacer shim” is a shim that in nature is simpler than the traditional dental shim shown in FIGS. 2A, 2B, and 2C. The improvement of a spacer shim is an improvement in reduced material resources, reduced manufacturing resources, reduced design resources, reduced shipping resources, reduced learning resources, and a decreased amount of time. These improvements permit an optionally disposable, optionally biodegradable, spacer shim to be mailed inexpensively to a user at their home so that they can use their mobile device to capture an image.

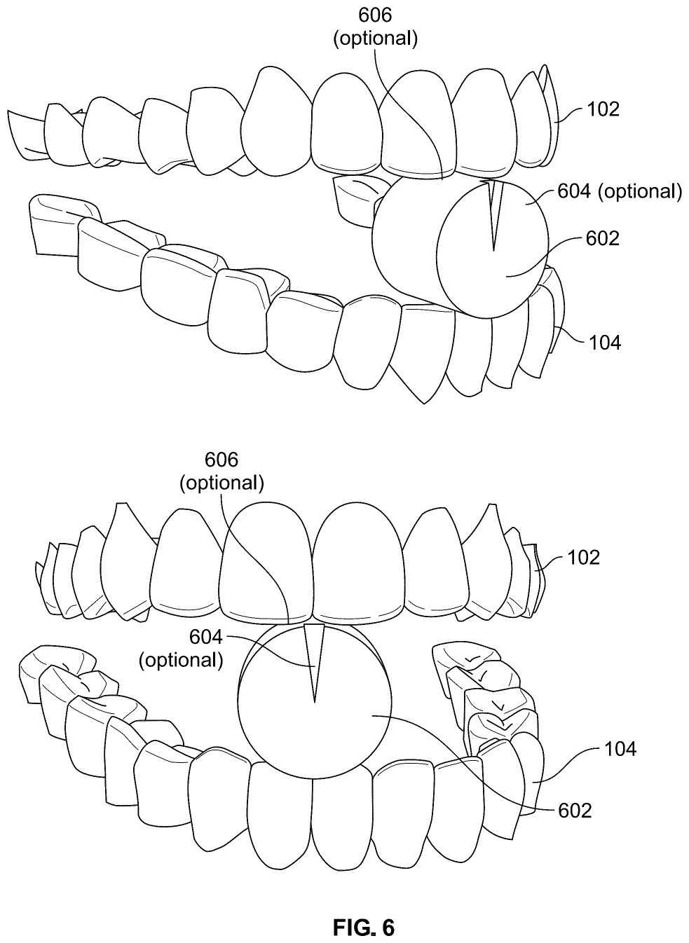

FIG. 6 depicts an example of a spacer shim device. In FIG. 6, the upper arch of a user's teeth (102) and the lower arch of a user's teeth (104) in an open bite position are shown in two perspective views. The spacer shim (602) maintains a front incisor distance between 10 mm and 25 mm, for example, with a simple cylinder of diameter 15 mm. Optionally, the spacer shim provides a visual and/or surface registration (604) for the captured image by providing a fiduciary to align with the front top incisor teeth for post-processing analysis of a captured image in relation to the upper arch and/or lower arch. Optionally, the spacer shim provides a détente (606) for the front top incisor teeth to help position the spacer shim for registration (604) and/or centering the front incisor distance in the mouth. The simple shim (602) may be made of an unyielding material such as plastic, or a slightly yielding material such as wood and/or foam.

Spacer Shim with Photo Capture. In one embodiment, a mobile device app assists a user in self-capturing an image. The workflow of the mobile device app guides a user to a first step to place the spacer shim, for example, aligning the spacer shim (602) with their pair of front top incisor teeth with the détente (606), a second step to smile in part drawing back their lips, and a third step to automatically and/or manually guide the mobile device for a “selfie” style photo with the size/resolution/angle/subject distance/lighting of the photograph to be best suited for capture and/or capture with registration. As referred to herein, registration provides a fiduciary to align three-dimensional objects such as an upper arch scan and/or lower arch scan in three-dimensional space using a two-dimensional image that has a visual registration marking (604) to assist alignment.

Spacer Shim with Intraoral Adapter. In one embodiment, a mobile device app assists a user in self-capturing an image with the use of an intraoral adapter and/or lips retractor. An example of an intraoral adapter is the Grin Scope® by Get-Grin Inc. The workflow of the mobile device app guides a user to a first step to place the spacer shim, for example, aligning the spacer shim (602) with their pair of front top incisor teeth with the détente (606), a second step to apply the intraoral adapter to the mobile device and/or apply the lips retractor to draw back their lips, and a third step to automatically and/or manually guide the mobile device for an intraoral adapter photo with the size/resolution/angle/subject distance/lighting of the photograph to be best suited for capture and/or capture with registration. A fiduciary like a visual registration marking (604) helps align three-dimensional objects such as an upper arch scan and/or lower arch scan in three-dimensional space using the two-dimensional captured photograph.

Spacer Shim with Depth Capture. In one embodiment, a mobile device app assists a user in self-capturing a scan that includes depth capture. Modern mobile devices may have a LiDAR (light detection and ranging) scanner, for example, the iPhone® 12 Pro and/or fourth generation of iPad® Pro from Apple, Inc. Modern mobile devices may have a depth camera, for example, iOS® devices from Apple, Inc. that have a TrueDepth camera, dual cameras, and/or spatial photos or video. The workflow of the mobile device app guides a user to a first step to place the spacer shim, for example, aligning the spacer shim (602) with their pair of front top incisor teeth with the détente (606), a second step to smile and/or use a lips retractor to draw back their lips, and a third step to automatically and/or manually guide the mobile device for a depth capture with the size/resolution/angle/subject distance of the photograph to be best suited for capture and/or capture with registration. In one embodiment, the depth camera is on the rear of the mobile device where no user display is located, and this third step guidance is given using audio guidance including audio cues. As referred to herein, registration also may provide a fiduciary to align three-dimensional objects such as an upper arch scan and/or lower arch scan in three-dimensional space using a three-dimensional scan such as the spacer shim depth scan that has a surface registration marking (604) to assist alignment.

Open Bite Position Scanning using Captured Motion. In some cases, a user's current upper arch scan and/or lower arch scan is not readily available, and/or it is challenging to mail a spacer shim to the user. The improvement of an open bit position scan without a spacer shim is an improvement in reduced material resources, reduced manufacturing resources, reduced design resources, reduced shipping resources, reduced learning resources, and a decreased amount of time.

Captured Motion using Intraoral Adapter. In one embodiment, a mobile device app assists a user in self-capturing a video with the use of an intraoral adapter and/or lips retractor. An example of an intraoral adapter is the Grin Scope® by Get-Grin Inc. The workflow of the mobile device app guides a user to a first step to apply the intraoral adapter to the mobile device and/or apply the lips retractor to draw back their lips, a second step to automatically and/or manually guide the mobile device for an intraoral adapter video capture with the size/resolution/angle/subject distance/lighting to be best suited for capture, and a third step to guide the user to move their mouth from a closed position to a fully open position or vice versa. In one embodiment, virtual articulation includes extracting frames and mapping three-dimensional position from captured motion to generate an upper arch model, a lower arch model, and an open bite position model of the user's teeth.

Captured Motion using Intraoral Jaw Motion Scanner. In one embodiment, a user may have motion captured using an intraoral jaw motion scanner. An example of an intraoral jaw motion three-dimensional scanner is the i-series and T-series scanners by Medit® Corporation. Another example of an intraoral jaw motion three-dimensional scanner is the spatial video capture scanner in the iPhone® 16 Pro by Apple, Inc. The workflow of the captured motion is to guide a user to a first step to apply the intraoral jaw motion scanner and to guide the user to move their mouth from a closed position to a fully open position or vice versa. In one embodiment, virtual articulation includes extracting scans from captured three-dimensional motion scans to extract and generate the open bite position model of the user's teeth for an incisor distance between 10 mm and 25 mm, for example, for 15 mm.

Using Empirical Articulation Models. In one embodiment, traditional empirical articulation models that use human anatomy and/or kinematic chains, including skeletal inverse kinematics/forward kinematics, and empirical relations of measurements between arches, jaws, and/or teeth are used in analysis.

In one embodiment, a measurement is estimated: from an image obtained associated with oral anatomy of a user; from an upper arch model of the user; and/or from a lower arch model of the user, and this measurement may be mapped into an empirical articulation model to provide a relative alignment between an upper arch of the user and the lower arch of the user.

In one embodiment, a measurement of a kinematic variable is made from the upper arch model of the user and/or from the lower arch model of the user, and this measured kinematic variable is used with the empirical articulation model to provide a relative alignment between an upper arch of the user and the lower arch of the user.

In one embodiment, an estimated measurement of the image and/or measurement of the kinematic variable from one or more arch models of the user is used with the empirical articulation model to provide a virtual articulation or provide a relative alignment between an upper arch of the user and the lower arch of the user.

Using Machine Learning/AI. In one embodiment, the user's mouth is classified into a particular group among a plurality of groups based on the determined relative alignment. Each group is associated with a particular type of jaw kinematics. In one embodiment, the classifier utilizes a heuristic approach to classify the images associated with the user's mouth into a particular jaw kinematics group. One or more of the images may illustrate wear patterns of the user's teeth. In one embodiment, the jaw kinematics associated with the user are based on wear patterns of the user's teeth.

The classifier may be trained using the images associated with a plurality of different users. The classifier may divide the plurality of different users into the plurality of different groups. Users within a particular group may have similar jaw kinematics. The classifier may determine that users have similar jaw kinematics based on values associated with one or more classifying features. Users within a particular group may have corresponding values associated with the one or more classifying features that are within a threshold tolerance.

The classifier analyzes the images of the user's oral anatomy to identify one or more classifying features associated with the user's oral anatomy. The classifier utilizes the one or more identified classified features to determine the particular group of users having similar values to the user for the one or more identified classified features, for example, values within a threshold tolerance. In one embodiment, the classifier utilizes machine learning to classify the jaw kinematics associated with the user into a particular group among a plurality of different groups.

Generating the Oral Insert. With the analysis described above for the scans and image and/or captured motion, an oral insert may be generated. In one embodiment, the oral insert is generated based on a classification of the user's oral anatomy. An upper portion and a lower portion of the oral insert may be aligned in a particular manner based on the particular group in which the user's oral anatomy is classified. The oral insert for may have certain features that are standard for users that are classified in the same group as the user. For example, the dimensions of the oral insert may be standardized for users within a classification group. Other features of the oral insert, such as a number of manifolds, a number of fluid nozzles, and a location of the fluid nozzles are customized for the user.

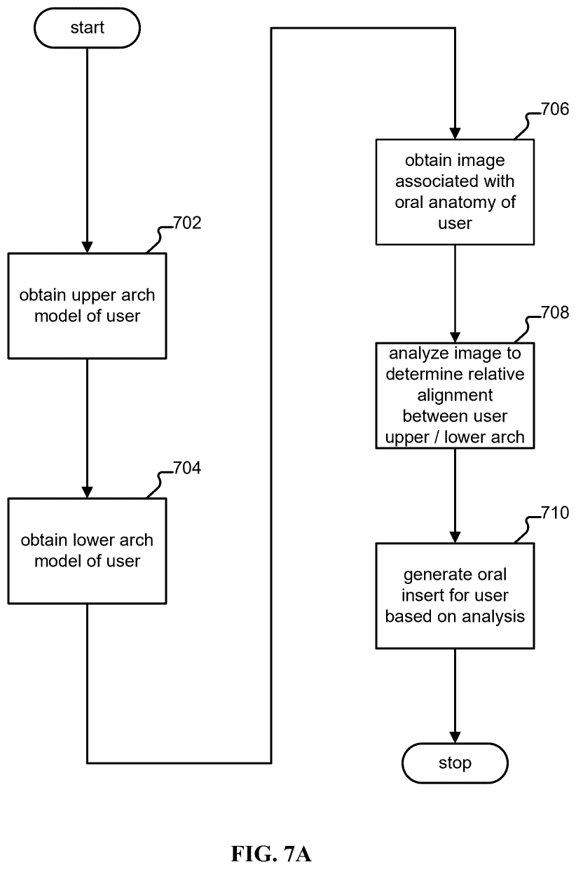

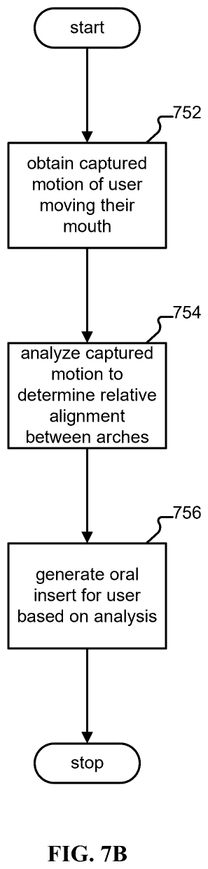

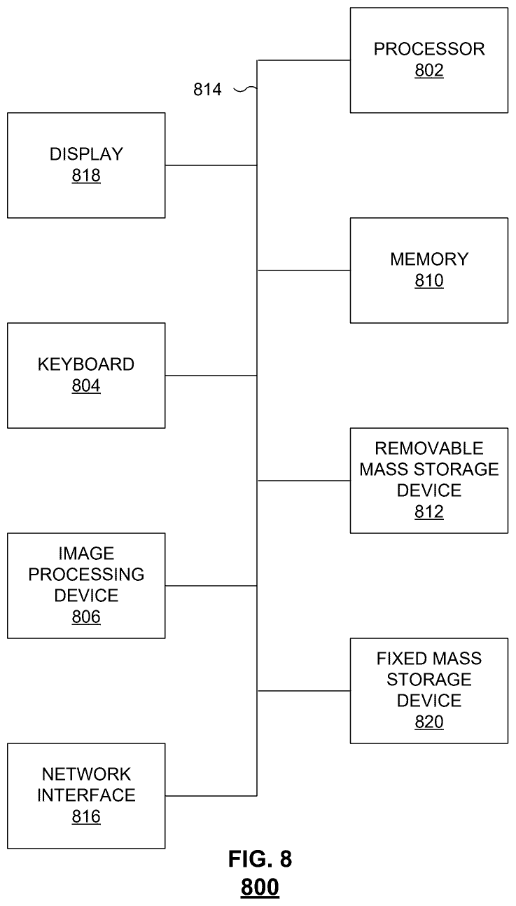

FIG. 7A is a flow diagram illustrating an embodiment of a process for open bite position scanning. In one embodiment, the flow diagram of FIG. 7A is carried out at least in part by an automated computer product, such as that described below in FIG. 8.

In optional step (702), an upper arch model of the user is obtained, for example, emailed and/or downloaded from the user's dentist. In one embodiment, the upper arch model is based at least in part on one of the following: an intraoral scan, an intraoral adapter, a lips retractor, and a dental impression. In one embodiment, the upper arch model is based at least in part on an image.

In optional step (704), a lower arch model of the user is obtained, for example, emailed and/or downloaded from the user's dentist. In one embodiment, the lower arch model is based at least in part on one of the following: an intraoral scan, an intraoral adapter for a mobile device, a lips retractor, and a dental impression.

In step (706), an image is obtained associated with oral anatomy of the user. For example, the image may be one captured with the user in an open bite. For example, the image may be a frame and/or scan of a captured motion with the user going from a closed bite to a fully open bite.

In one embodiment, the image is at least one of the following: a frame from a video, an image from an intraoral adapter, an image using a lips retractor, an image of a shimmed bite using a physical shim, an image using a physical registration fiduciary device, a mobile device LiDAR scan, a mobile device depth scan, and a spatial photo.

In one embodiment, the image is a frame from a video capture of the user moving their mouth using an intraoral adapter for a mobile device or a photograph from a mobile device of a shimmed bite using a physical shim. In one embodiment, the image is a rendering from a scan of the user moving their mouth using an intraoral jaw movement scanner.

In step (708), the image from step (706), and optionally the upper arch model/lower arch model are analyzed to determine a relative alignment between an upper arch of the user and a lower arch of the user. In one embodiment, analyzing the image, the upper arch model, and the lower arch model comprises recognizing an upper registration between the image and the upper arch model or a lower registration between the image and the lower arch model.

In one embodiment, the relative alignment comprises an open bite position, with a front incisor distance between 10 mm and 25 mm, conforming to the user's natural jaw kinematics.

In one embodiment, in a step not shown in FIG. 7A, an empirical articulation model is obtained, and wherein analyzing the image, the upper arch model, and the lower arch model comprises mapping an estimated measurement on the image to the empirical articulation model.

In one embodiment, in a step not shown in FIG. 7A, an empirical articulation model is obtained, and wherein analyzing the image, the upper arch model, and the lower arch model comprises measuring kinematic variables on the upper arch model or lower arch model for the empirical articulation model.

In one embodiment, in a step not shown in FIG. 7A, an empirical articulation model is obtained, and wherein analyzing the image, the upper arch model, and the lower arch model comprises virtually articulating the upper arch model and lower arch model together using the empirical articulation model based at least in part on one of the following: an estimated measurement on the image, a measured upper arch kinematic variable on the upper arch model, and a measured lower arch kinematic variable on the lower arch model.

In one embodiment, in a step not shown in FIG. 7A, a machine learning bite model is obtained, and wherein analyzing the image, the upper arch model, and the lower arch model comprises identifying a classifying feature of the image. In one embodiment, analyzing the image comprises classifying the user to a user group with similar jaw kinematics based at least in part on the classifying feature and the machine learning bite model. In one embodiment, the classifying feature of the image comprises wear patterns of the user's teeth. In step (710), an oral insert is generated for the user based on the analysis in step (708).

FIG. 7B is a flow diagram illustrating an embodiment of a process for open bite position scanning using captured motion. In one embodiment, the flow diagram of FIG. 7B is carried out at least in part by an automated computer product, such as that described below in FIG. 8.

In step (752), a captured motion of a user moving their mouth is obtained. In one embodiment, the captured motion is a video capture of the user moving their mouth using an intraoral adapter for a mobile device. In one embodiment, the captured motion is a scan of the user moving their mouth using an intraoral jaw movement scanner.

In step (754), the captured motion is analyzed to determine a relative alignment between an upper arch of the user and a lower arch of the user and to generate an upper arch model and a lower arch model for the user.

In step (756), an oral insert having a plurality of fluid nozzles and a plurality of fluid manifolds is generated for the user based on the analysis of the captured motion and the generated upper arch model and the generated lower arch model.

FIG. 8 is a functional diagram illustrating a server for open bite scanning and/or generating an oral insert in accordance with some embodiments. As will be apparent, other server architectures and configurations can be used to perform the described scanning/generating. Server 800, which includes various subsystems as described below, includes at least one microprocessor subsystem (also referred to as a processor or a central processing unit (CPU) 802). For example, processor 802 can be implemented by a single-chip processor or by multiple processors. In some embodiments, processor 802 is a general purpose digital processor that controls the operation of the server 800. In some embodiments, processor 802 also includes one or more coprocessors or special purpose processors (e.g., a graphics processor, a network processor, etc.). Using instructions retrieved from memory 810, processor 802 controls the reception and manipulation of input data received on an input device (e.g., image processing device 806, I/O device interface 804), and the output and display of data on output devices (e.g., display 818).

Processor 802 is coupled bi-directionally with memory 810, which can include, for example, one or more random access memories (RAM) and/or one or more read-only memories (ROM). As is well known in the art, memory 810 can be used as a general storage area, a temporary (e.g., scratch pad) memory, and/or a cache memory. Memory 810 can also be used to store input data and processed data, as well as to store programming instructions and data, in the form of data objects and text objects, in addition to other data and instructions for processes operating on processor 802. Also as is well known in the art, memory 810 typically includes basic operating instructions, program code, data, and objects used by the processor 802 to perform its functions (e.g., programmed instructions). For example, memory 810 can include any suitable computer readable storage media described below, depending on whether, for example, data access needs to be bi-directional or uni-directional. For example, processor 802 can also directly and very rapidly retrieve and store frequently needed data in a cache memory included in memory 810.

A removable mass storage device 812 provides additional data storage capacity for the server 800, and is optionally coupled either bi-directionally (read/write) or uni-directionally (read only) to processor 802. A fixed mass storage 820 can also, for example, provide additional data storage capacity. For example, storage devices 812 and/or 820 can include computer readable media such as magnetic tape, flash memory, PC-CARDS, portable mass storage devices such as hard drives (e.g., magnetic, optical, or solid state drives), holographic storage devices, and other storage devices. Mass storages 812 and/or 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can be used to provide access to other subsystems and devices as well. As shown, these can include a display 818, a network interface 816, an input/output (I/O) device interface 804, an image processing device 806, as well as other subsystems and devices. For example, image processing device 806 can include a camera, a scanner, etc.; I/O device interface 804 can include a device interface for interacting with a touchscreen (e.g., a capacitive touch sensitive screen that supports gesture interpretation), a microphone, a sound card, a speaker, a keyboard, a pointing device (e.g., a mouse, a stylus, a human finger), a Global Positioning System (GPS) receiver, an accelerometer, and/or any other appropriate device interface for interacting with system 800. Multiple I/O device interfaces can be used in conjunction with server 800. The I/O device interface can include general and customized interfaces that allow the processor 802 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 816 allows processor 802 to be coupled to another computer, one or more robotic systems, computer network, a network of storage bins, or telecommunications network using a network connection as shown. For example, through the network interface 816, the processor 802 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the server 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

In addition, various embodiments disclosed herein further relate to computer storage products with a computer readable medium that includes program code for performing various computer-implemented operations. The computer readable medium includes any data storage device that can store data which can thereafter be read by a server. Examples of computer readable media include, but are not limited to: magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The server shown in FIG. 8 is but an example of a server suitable for use with the various embodiments disclosed herein. Other servers suitable for such use can include additional or fewer subsystems. In some servers, subsystems can share components (e.g., for touchscreen-based devices such as smart phones, tablets, etc., I/O device interface 804 and display 818 share the touch sensitive screen component, which both detects user inputs and displays outputs to the user). In addition, bus 814 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
obtaining an upper arch model of a user;
obtaining a lower arch model of the user;
obtaining an image associated with an oral anatomy of the user;
analyzing the image, the upper arch model, and the lower arch model to determine a relative alignment between an upper arch of the user and a lower arch of the user; and
generating an oral insert having a plurality of fluid nozzles and a plurality of fluid manifolds for the user based on the analysis of the image, the upper arch model, and the lower arch model.

2. The method of claim 1, wherein the image is at least one of the following: a frame from a video, an image from an intraoral adapter, an image using a lips retractor, an image of a shimmed bite using a physical shim, an image using a physical registration fiduciary device, a mobile device LiDAR scan, a mobile device depth scan, and a spatial photo.

3. The method of claim 1, wherein the upper arch model is based at least in part on one of the following: an intraoral scan, an intraoral adapter, a lips retractor, and a dental impression.

4. The method of claim 1, wherein the lower arch model is based at least in part on one of the following: an intraoral scan, an intraoral adapter for a mobile device, a lips retractor, and a dental impression.

5. The method of claim 1, wherein the upper arch model is based at least in part on an upper arch image.

6. The method of claim 1, wherein analyzing the image, the upper arch model, and the lower arch model comprises recognizing an upper registration between the image and the upper arch model or a lower registration between the image and the lower arch model.

7. The method of claim 1, wherein the relative alignment comprises an open bite position, with a front incisor distance of between 10 mm and 25 mm, conforming to the user's natural jaw kinematics.

8. The method of claim 1, further comprising obtaining an empirical articulation model, and wherein analyzing the image, the upper arch model, and the lower arch model comprises mapping an estimated measurement on the image to the empirical articulation model.

9. The method of claim 1, further comprising obtaining an empirical articulation model, and wherein analyzing the image, the upper arch model, and the lower arch model comprises measuring kinematic variables on the upper arch model or the lower arch model for the empirical articulation model.

10. The method of claim 1, further comprising obtaining an empirical articulation model, and wherein analyzing the image, the upper arch model, and the lower arch model comprises virtually articulating the upper arch model and the lower arch model together using the empirical articulation model based at least in part on one of the following: an estimated measurement on the image, a measured upper arch kinematic variable on the upper arch model, and a measured lower arch kinematic variable on the lower arch model.

11. The method of claim 1, further comprising obtaining a machine learning bite model, and wherein analyzing the image, the upper arch model, and the lower arch model comprises identifying a classifying feature of the image.

12. The method of claim 11, wherein analyzing the image comprises classifying the user to a user group with similar jaw kinematics based at least in part on the classifying feature and the machine learning bite model.

13. The method of claim 11, wherein the classifying feature of the image comprises wear patterns of the user's teeth.

14. The method of claim 1, wherein the image is a frame from a video capture of the user moving their mouth using an intraoral adapter for a mobile device or a photograph from a mobile device of a shimmed bite using a physical shim.

15. The method of claim 1, wherein the image is a rendering from a scan of the user moving their mouth using an intraoral jaw movement scanner.

16. A method, comprising:
obtaining a captured motion of a user moving their mouth;
analyzing the captured motion to determine a relative alignment between an upper arch of the user and a lower arch of the user and to generate an upper arch model and a lower arch model for the user; and
generating an oral insert having a plurality of fluid nozzles and a plurality of fluid manifolds for the user based on the analysis of the captured motion and the generated upper arch model and the generated lower arch model.

17. The method of claim 16, wherein the captured motion is a video capture of the user moving their mouth using an intraoral adapter for a mobile device.

18. The method of claim 16, wherein the captured motion is a scan of the user moving their mouth using an intraoral jaw movement scanner.

19. A system, comprising:
a communications interface; and
a processor coupled to the communications interface and configured to:
obtain an upper arch model of a user via the communications interface;
obtain a lower arch model of the user via the communications interface;
obtain an image associated with an oral anatomy of the user via the communications interface;
analyze the image, the upper arch model, and the lower arch model to determine a relative alignment between an upper arch of the user and a lower arch of the user;
generate an oral insert model having a plurality of fluid nozzles and a plurality of fluid manifolds for the user based on the analysis of the image, the upper arch model, and the lower arch model; and
transmit the oral insert model for generation.

20. A computer program product embodied in a non-transitory computer readable medium and comprising computer instructions for:
obtaining an upper arch model of a user;
obtaining a lower arch model of the user;
obtaining an image associated with an oral anatomy of the user;
analyzing the image, the upper arch model, and the lower arch model to determine a relative alignment between an upper arch of the user and a lower arch of the user; and
generating an oral insert having a plurality of fluid nozzles and a plurality of fluid manifolds for the user based on the analysis of the image, the upper arch model, and the lower arch model.
